(19) United States
(12) Patent Application Publication
(10) Pub. No.: US 2023/0133986 A1
(43) Pub. Date: May 4, 2023

(54) Brake Actuating Device

(71) Applicant: Robert Bosch GmbH, Stuttgart (DE)

(72) Inventors: Andreas Weh, Sulzberg (DE); Enzo Perini, Vincennes (FR); Matthias Mayr, Rettenberg (DE); Raynald Sprocq, Esbly (FR); Shogo Miyoshi, Yokohama-shi (JP)

(21) Appl. No.: 17/971,354

(22) Filed: Oct. 21, 2022

(30) Foreign Application Priority Data
Nov. 2, 2021 (DE) 10 2021 212 295.7

(51) Int. Cl. B60T 13/14

(52) U.S. Cl. CPC B60T 13/142; B60T 7/06

(57) ABSTRACT

A brake actuating device of a vehicle brake system has a pump housing which has a housing opening surrounded by a wall. The housing opening includes a housing axis along which a piston is to be accommodated in the housing opening in an axially displaceable manner. The housing opening further has a guide region in which a guide element to be arranged between the wall and the piston is to be accommodated. The brake actuating device further has a projection projecting from the wall into the housing opening. The projection is provided axially next to the guide region in the housing opening. The guide element is placed axially on the projection.

This application claims priority under 35 U.S.C. § 119 to patent application no. DE 10 2021 212 295.7, filed on Nov. 2, 2021 in Germany, the disclosure of which is incorporated herein by reference in its entirety.

The disclosure relates to a brake actuating device, in particular of a vehicle brake system, having a pump housing which has a housing opening surrounded by a wall, wherein the housing opening comprises a housing axis along which a piston is to be accommodated in the housing opening in an axially displaceable manner, and comprises a guide region in which a guide element to be arranged between the wall and the piston is to be accommodated. The disclosure further relates to the use of such a brake actuating device in a vehicle brake system.

### BACKGROUND

Generic vehicle brake systems are used to decelerate the driving speed of vehicles such as cars and trucks. For this purpose, hydraulic brake systems are usually used, with which functions of an anti-lock braking system (ABS) and/or an electronic stability program (ESP) are also realized. A controlled brake pressure is provided in associated brake circuits by means of a hydraulic assembly and a hydraulic fluid. To generate the brake pressure, a pedal-actuatable master brake cylinder is provided to which usually two brake circuits are connected, each comprising a brake line through which hydraulic fluid can flow. If a brake pedal is actuated by a driver, a mechanical force exerted therewith is converted into a hydraulic force by increasing a pressure on the hydraulic fluid. This force then acts as a braking force on associated wheel brakes.

Known master brake cylinders or pressure-generating cylinders generally have a brake actuating device, which is usually designed in a block shape or as a block. A housing opening with a housing axis, in which housing opening a cylinder and a piston are arranged, is formed by means of a bore hole in the block. The piston is axially displaceable in the cylinder or the housing opening by the brake pedal, and is sealed from the outside by at least one sealing ring in the housing opening. In addition, the piston is guided during its translational movement along the housing axis by a guide element arranged radially around the piston. In this case, the guide element is used, in particular, to support against transverse forces which occur predominantly while actuating the brake pedal during operation. Such a brake actuating device is known from DE 10 2015 207 634 A1.

### SUMMARY

The disclosure relates to a brake actuating device or a braking request specification device, in particular of a vehicle brake system, comprising a pump housing which has a housing opening surrounded by a wall, wherein the housing opening comprises a housing axis along which a piston is to be accommodated in the housing opening in an axially displaceable manner, and comprises a guide region in which a guide element to be arranged between the wall and the piston is to be accommodated. In this case, a projection projecting from the wall into the housing opening is provided axially next to the guide region in the housing opening, on which projection the guide element is to be axially placed.

The projection therefore projects from the wall and extends into the housing opening or an interior of the pump housing or housing created by the wall. In addition, the projection is arranged in particular directly next to the guide region. If the guide element accommodated in the guide region is axially placed on the projection, axial forces acting on the guide element during assembly and operation are absorbed by the projection. Thus absorbed, the forces are transmitted from the projection to the housing. In comparison to the guide element, the housing is substantially larger and comprises more material, so that the axial forces acting on the guide element are absorbed by the housing in a manner distributed over a wide region. Such a force distribution acts in a particularly stabilizing and gentle manner on involved components. The axial forces that occur are, in particular, axially acting assembly forces, frictional forces acting when the piston is moving into the housing opening, and functional forces acting as a result of hydraulic pressure. According to the disclosure, a brake actuating device is therefore created by means of which forces arising during the assembly and operation of the piston pump can be absorbed in a particularly well distributed manner by the housing itself. In addition, the piston which is guided by the guide element placed on the projection receives additional stability. It is therefore sufficient to design the guide element with a reduced diameter and a reduced length in comparison to a conventional guide element. A particularly lightweight brake actuating device is created.

In addition, the projection or protrusion according to the disclosure creates a housing opening which in particular has a substantially similar cross section in the axial direction before and behind the projection. Only in the region of the projection is the cross section and therefore the interior of the housing reduced. A relatively large interior space is thereby created, in particular axially within the projection, which provides space for further pump elements. Preferably, a sealing element can be positioned therein.

The projection is preferably designed as a bar. Such a bar extends radially into the housing opening and is designed to be relatively flat in the axial direction. It has been found that, despite its small axial extension, such a bar has a surprisingly good stabilizing effect on arising contact forces.

In addition, the projection and in particular the bar has, on its side or outer side facing toward the guide element, a substantially flat surface for applying the guide element. There, the guide element can be or is applied in a particularly stable and effective force-transmitting manner. The guide element, by means of its contact side facing toward the projection, can be or is applied to the projection preferably over the entire contact side in a particularly effective force-transmitting manner.

More preferably, the projection is designed to extend transversely to the housing axis, particularly preferably approximately at a right angle to the housing axis. A particularly uniform force distribution is therefore achieved together with, at the same time, an advantageous spatial design for further components.

Furthermore, the housing is preferably designed in a block shape, whereby arising forces are absorbed in a particularly effective force-distributing manner. Particularly preferably, the housing in particular of the master brake cylinder is integrated in a hydraulic block. This creates a very compact and space-saving brake system.

According to the disclosure, the projection is advantageously designed integrally with the housing. The projection is therefore arranged in a particularly stable manner on the housing, and force transmitted by means of the projection to the housing is particularly high.

In addition, according to the disclosure, the housing opening advantageously comprises a sealing region in which a sealing element to be arranged between the wall and the piston is to be accommodated. In this case, the sealing region is arranged on a side of the projection opposite the guide region so that the projection is located axially between the guide region and the sealing region. When the sealing element is accommodated in the sealing region, the sealing element is therefore arranged radially between the wall and the piston and axially on a side or sealing side of the projection facing away from the guide element. The sealing side of the projection is a side which faces the interior of the housing and has an inner surface on which the sealing element is axially placed. The projection is therefore positioned axially between the sealing element and the guide element, and correspondingly directly absorbs acting axial forces and transmits them to the housing. For this purpose, the sealing element is preferably designed with a sealing ring which completely surrounds the piston radially. A particularly good sealing effect is therefore achieved.

The brake actuating device according to the disclosure is preferably part of a master brake cylinder. This results in axial forces acting on the sealing element from the interior in the direction of the projection, in particular during a return stroke of the piston caused by releasing the brake pedal. These forces are absorbed by the projection and transmitted to the housing. By means of such a force absorption, the sealing element is conserved and stabilized during operation. A particularly reliable and durable sealing effect of the brake actuating device in the master brake cylinder is therefore achieved. Axial forces directed from the outside in the direction of the interior occur while assembling the brake actuating device and during operation by a forward movement of the piston, in particular when the brake pedal is actuated. Correspondingly acting assembly forces, functional forces and frictional forces are also absorbed by the projection.

The guide element is preferably designed with a guide ring. The guide ring is to be arranged radially around the piston, and therefore completely surrounds the piston over its circumference on its lateral surface in an assembled state. The piston is therefore particularly compact, stable and uniformly guided.

In addition, according to the disclosure, the guide element advantageously has a radial outer surface which is designed with a transition fit to be positioned axially in the direction of the projection. The transition fit is in particular a radial press fit which aligns the guide element coaxially with the housing opening. This facilitates targeted assembly when the guide element is pressed in the direction of the projection. In addition, the transition fit creates a certain play between the guide element and the wall of the housing. Accordingly, the transition fit is preferably designed with a reduction in the diameter of the guide element in the direction of the projection, particularly preferably as a radially inward facing bevel or gradation.

Furthermore, according to the disclosure, the guide element advantageously has a radial inner surface which is designed with a bevel to be positioned axially in the direction of the projection. The guide element is therefore designed to taper radially inward in the direction of the projection. Thus, deformations which are generated during a pressing-in process of the guide element into the interior are accommodated in the guide element. A guide region of the guide element facing the piston is then not deformed in an undesired braking manner after pressing in, but rather is protected by means of the bevel.

According to the disclosure, the guide element furthermore advantageously has a radial outer surface which is designed with a step which is directed radially inward and is to be positioned axially remote from the projection. With such a step, a shoulder on the guide element is created axially opposite the contact side of the guide element, which shoulder is positioned opposite the projection in the brake actuating device. Further components on the guide element can preferably be arranged or placed in a space-saving manner on the shoulder. Particularly preferably, the guide element is held compactly on the housing by press-fitting the housing on the shoulder.

For this purpose, at least one segment is advantageously provided according to the disclosure, with which segment the step of the guide element and the housing are press-fit when the guide element is accommodated in the guide region of the housing opening. In particular for this purpose, the individual segment comprises a material which is placed in a form-fitting manner, by means of press-fitting, over the shoulder of the guide element produced by the step, and an associated interface of the housing. The associated interface is located at a mouth of the housing opening into which the piston and the guide element are introduced. Such a segmental press-fit in combination with the projection according to the disclosure is sufficient to counteract an arising hydraulic pressure in the interior of the housing. By means of the projection, the hydraulic pressure is absorbed via the projection and therefore directly in the housing. The press-fitting of the guide element is therefore not stressed.

The individual segment is preferably designed with a material introduced from the outside. The press-fitting is therefore flexible with regard to required material properties. Particularly preferably, the individual segment is formed on the interface of the housing by the material of the housing itself. For this purpose, the housing is correspondingly deformed during press-fitting on the individual segment, which yields simple and material-saving assembly. More preferably, at least two segments are provided with which stable partial press-fitting is achieved. Particularly preferably, four segments are provided, which are arranged in particular at the same distance from one another. Material-saving and nevertheless sufficiently stable segment press-fitting is therefore achieved by means of a partial form-fit.

According to the disclosure, the at least one segment is advantageously designed to be punctiform. A particularly space-saving connection of the guide element to the housing is therefore produced.

Furthermore, according to the disclosure, at least one cavity is preferably provided radially next to the guide region outside the housing opening in the pump housing. The individual cavity is preferably arranged at a distance from the housing opening. Given a block-shaped housing and a borehole forming the housing opening, the individual cavity is in particular a recess which is arranged radially to the housing opening and extends axially parallel to the housing axis. If the guide element is accommodated in the guide region, the at least one cavity is arranged radially around the guide element. The guide element is therefore surrounded radially in portions by at least one cavity. For this purpose, the individual cavity is preferably arranged eccentrically and particularly preferably centrically with respect to the housing axis. The individual cavity therefore serves as a buffer for the guide element, by means of which buffer forces acting in particular radially from the outside are absorbed, and the guide element is therefore protected.

According to the disclosure, the individual cavity is advantageously provided in the region of an associated ball lock which is arranged in the housing peripherally to the guide region of the housing opening. Preferably, at least two ball locks are provided which are arranged eccentrically peripherally to the guide region of the housing opening. In this case, the individual ball lock with its associated ball leads to deformations in the guide region, which are accommodated and compensated for by the at least one cavity in the housing. The deformations therefore do not overlap the centric diameter of the guide element so that negative effects of the deformations on the guide region are avoided.

In addition, the disclosure relates to a use of such a brake actuating device on or in a master brake cylinder of a vehicle brake system, wherein in particular the master brake cylinder is integrated in a hydraulic block of a hydraulic assembly. In this way, a particularly lightweight, space-saving and cost-effective vehicle brake system is provided, as can also be seen from the aforementioned advantages of the brake actuating device.

### BRIEF DESCRIPTION OF THE DRAWINGS

Exemplary embodiments of the solution according to the disclosure are explained in more detail below with reference to the attached schematic drawings. In the drawings:

FIG. 1 shows a section of a hydraulic diagram with a master brake cylinder on which the disclosure is based,

FIG. 2 shows a longitudinal section of a part of the master brake cylinder according to FIG. 1,

FIG. 3 shows the detail III in FIG. 2,

FIG. 4 shows a part of a longitudinal section of a first exemplary embodiment of a brake actuating device according to the disclosure without a piston,

FIG. 5 shows the detail V according to FIG. 4,

FIG. 6 shows the view VI according to FIG. 4 with a piston,

FIG. 7 shows the section VII-VII according to FIG. 6,

FIG. 8 shows the view according to FIG. 6 of a second exemplary embodiment of a brake actuating device according to the disclosure, and

FIG. 9 shows the section IX-IX according to FIG. 8.

### DETAILED DESCRIPTION

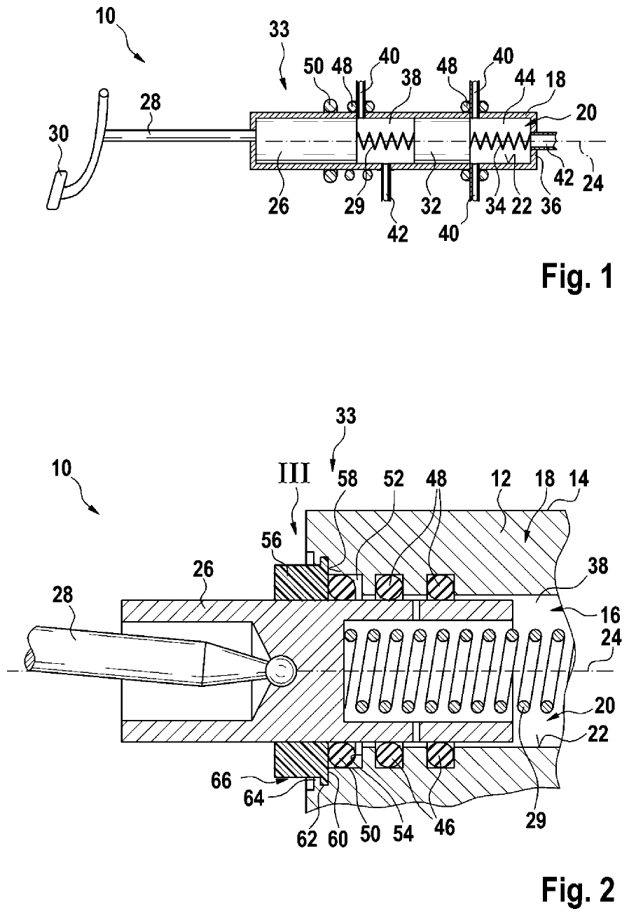

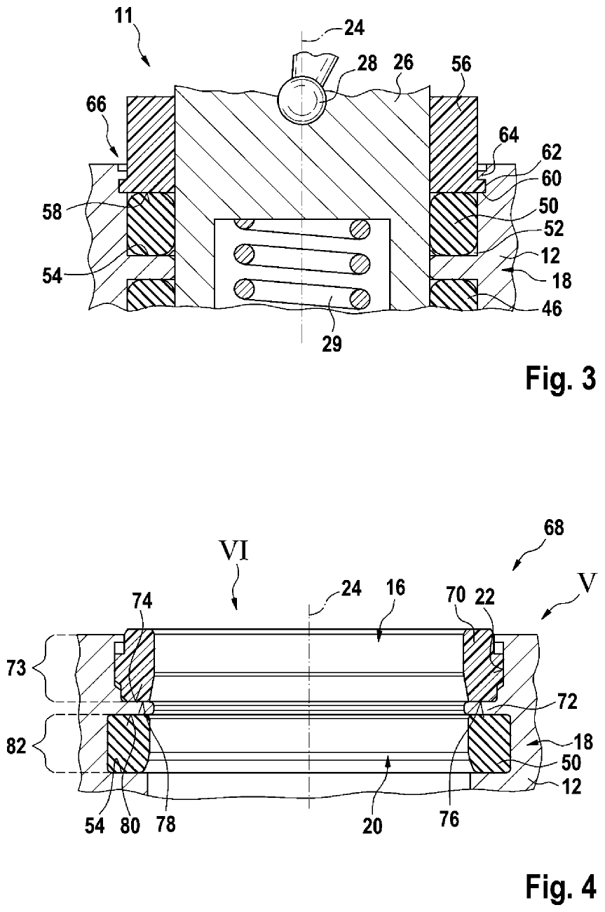

FIGS. 1 to 3 show a highly schematic master brake cylinder 10 and an associated brake actuating device 11 of a hydraulic vehicle brake system (not shown in further detail), as used in brake systems with slip control systems such as ABS and ESP. In the present case, the master brake cylinder 10 is integrated in a cuboid hydraulic block 12 made of aluminum, which is only partially shown in the figures. A so-called one-box system and therefore a so-called integrated power brake (IPB) is present which is to be assembled directly on a bulkhead (not shown) of a vehicle.

The master brake cylinder 10 is arranged in a master brake cylinder borehole as a housing opening 16 provided parallel to a transverse side 14 of the hydraulic block 12. The housing opening 16 and the hydraulic block 12 provide a pump housing 18, in which the housing opening 16 forms an interior 20 which is surrounded by a wall 22 and has a housing axis 24.

The housing axis 24 corresponds to a piston axis associated with a piston 26. In this case, the piston 26 is connected in an articulated manner outside the pump housing or housing 18 to a piston rod 28 which is coupled to a brake pedal 30 which can be actuated by a user of the vehicle. When the brake pedal 30 is actuated, the piston 26 is mechanically moved along the housing axis 24 in the housing opening 16 by means of the piston rod 28. The piston 26 is a so-called rod piston or primary piston which is braced by a compression spring 29 against a second piston 32 arranged axially downstream from the piston 26. In addition, the second piston 32 is axially displaceable and braced by a second compression spring 34 against a housing side 36 opposite the piston 26 at the end face. The piston 32 is also called a pressure piston or secondary piston. A piston pump 33 is therefore formed with two brake cylinders, arranged axially one behind the other, of a master brake cylinder 10 designed as a tandem master brake cylinder.

Given this design, a dual-circuit brake system (not shown) is to be actuated. For this purpose, a first pressure chamber 38 is located between the two pistons 26 and 32 and the housing 18, into which pressure chamber a hydraulic fluid or fluid from a storage container (not shown) is sucked through a line 40. The fluid is then to be pumped through a further line 42 into a first brake circuit. A second pressure chamber 44 provided between the piston 32 and the housing side 36 is equipped with corresponding lines 40 and 42, with which a second brake circuit is to be supplied with fluid. When the brake pedal 30 is actuated, the piston 26 is pushed into the housing opening 16 and thereby generates a hydraulic pressure in the first pressure chamber 38. The pressure shifts the piston 32 in the direction of the housing side 36, whereby hydraulic pressure is generated in the second pressure chamber 44.

Both pistons 26 and 32 are sealed in the interior 20 by radially surrounding sealing rings 46. For this purpose, each sealing ring 46 is arranged in an associated annular groove 48 in the wall 22. Furthermore, an additional sealing element 50 designed as a sealing ring is provided radially around the piston 26 in the direction of the piston rod 28. The sealing element 50 is accommodated in an annular space 52 which is created by means of an annular step 54 of the wall 22 that extends radially outward. The sealing ring 46 closest to the step 54 is referred to as the first insulation seal, and the sealing element 50 itself is referred to as the second insulation seal.

Furthermore, a guide element 56 is provided in the brake actuating device 11 axially outside the sealing element 50, which guide element radially surrounds the piston 26 as a guide ring. The guide element 56 serves to absorb axial and transverse forces arising during operation. The transverse forces occur primarily when the brake pedal 30 is actuated, since the piston rod 28, at its end remote from the piston 26, is moved by the brake pedal 30 on a circular path. The axial forces are primarily caused by hydraulic pressure.

In this case, the guide element 56 in the brake actuating device 11 is axially arranged with its contact surface 58 directly on the sealing element 50. In addition, the guide element 56 is axially placed radially on the outside with a small region of the contact surface 58 on a further step 60 of the housing opening 16. In this case, the wall 22 of the interior 20 is displaced further radially outwards with the further step 60 compared to the step 54. Furthermore, a circumferential, radially outwardly projecting edge 62 is provided on the guide element 56, which edge is fastened to the housing 18 by means of press-fitting. The press-fit 64 is a plastic deformation of material of the housing 18 around a mouth 66 surrounding the housing opening 16, which mouth overlaps the edge 62. The guide element 56 is therefore held axially on or in the housing 18.

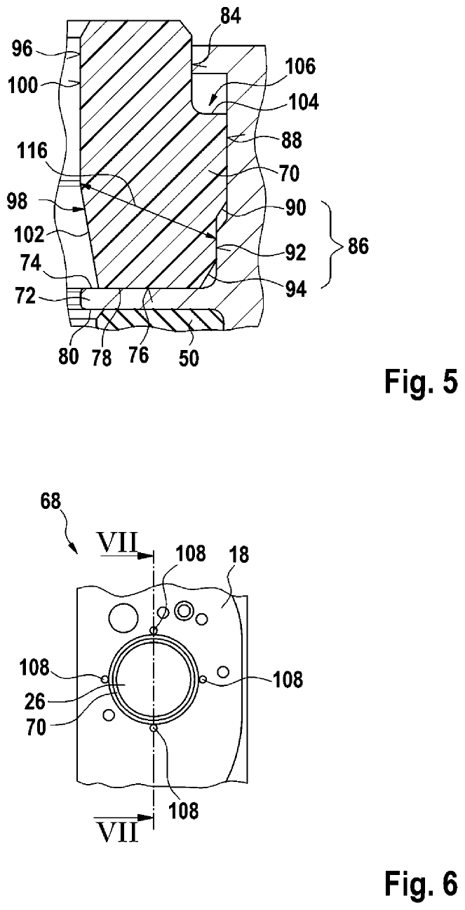

FIGS. 4 to 7 show an exemplary embodiment of a brake actuating device 68 which is shown in part without the piston 26 for better clarity. In contrast to the brake actuating device 11, a projection 72 is provided in the interior 20, on which projection a guide element 70 is axially placed. For this purpose, the guide element 70 is accommodated in a guide region 73 which extends in the housing opening 16 from the projection 72 in the direction of the mouth 66. In contrast to the step 60, the projection 72 projects radially inward from the wall 22 into the housing opening 16. Furthermore, the projection 72 in the form of an annular bar is designed as a flat component which extends transversely at a right angle to the housing axis 24 into the interior 20 and is designed integrally with the housing 18.

In this case, the projection 72 has an outer side 74 which faces away from the interior 20 in the axial direction, and on which the guide element 70 is axially placed by its contact surface 76. Both the contact surface 76 and the outer side 74 are designed as a flat ring and are also largely flat. Furthermore, the contact surface 76 extends completely over its contact side 78 of the guide element 70 facing the projection 72. A substantially larger contact area of the guide element 70 on the projection 72 is therefore created in comparison with the small section of the contact surface 58 of the guide element 56 at the step 60. In this way, axially acting forces are absorbed more extensively by the guide element 70 and correspondingly transmitted more extensively to the block-shaped housing 18.

Opposite the outer side 74 and facing into the interior 20, the projection 72 has an annular and largely flat interior or side 80 which is opposite the guide element 70. A sealing region 82 of the housing opening 16, in which the sealing element 50 designed as a sealing ring and lip seal is arranged, is provided axially between the side 80 and the step 54. Thus, forces on the side 80 acting axially from the inside to the outside are transmitted via the sealing element 50 to the projection 72 and from there to the housing 18.

In addition, the guide element 70 has a radial outer surface 84 on its circumference, which surface is formed with a transition fit 86 in the direction of its contact surface 76 and therefore in the direction of the outer side 74 of the projection 72. The transition fit 86, starting from a lateral surface 88 of the guide element 70, is designed with a first bevel 90 facing radially inward in the direction of the projection 72. Following the first bevel 90, a lateral surface 92 with a smaller diameter in comparison with the lateral surface 88 is provided, and a radially inward facing second bevel 94 is connected thereto. Furthermore, radially to the inside, the guide element 70 comprises a radial inner surface 96 which is designed to taper in the direction of the projection 72 with a bevel 98. Starting from an inner lateral surface 100, the bevel 98 is formed with a radially outwardly directed bevel 102.

For assembling the guide element 70 on the housing 18, the guide element 70 is introduced and pressed into the housing opening 16 at the mouth 66 in a first assembly step. In so doing, the transition fit 86 facilitates targeted introduction with corresponding play. In a further pressing-in operation, the guide element 70 is pressed into the interior 20 until the guide element 70 rests against the projection 72 on its outer side 74. An excess force that occurs is absorbed by the projection 72 of the housing 18. In addition, deformations produced by the pressing-in process are absorbed by the bevel 98.

Furthermore, the radial outer surface 84 of the guide element 70 is designed with a radially inward directed step 104 remote from the projection 72. With the step 104, an offset shoulder 106 is provided on the guide element 70 opposite the contact surface 76, which shoulder extends, in the present case, radially circumferentially over the entire circumference of the guide element 70.

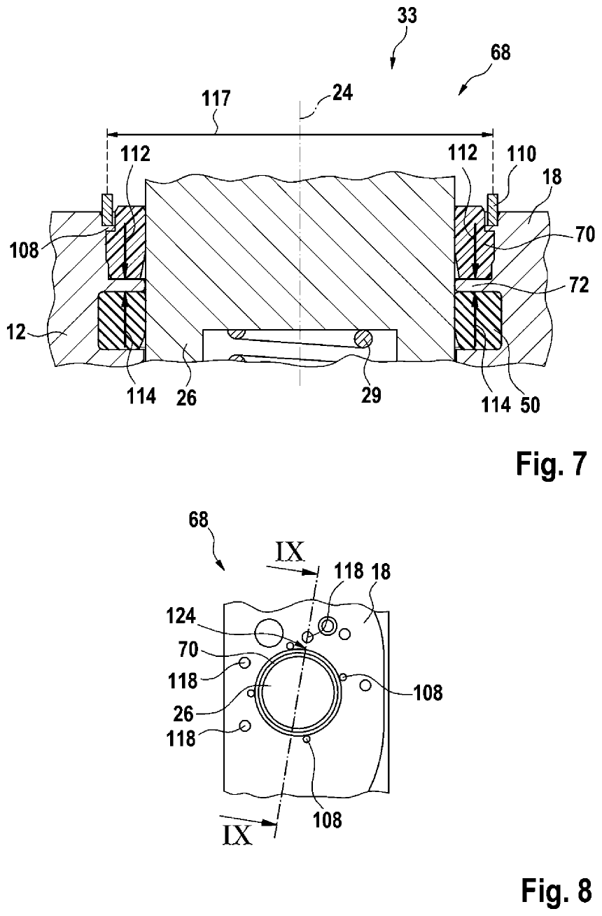

For further assembly of the guide element 70, the shoulder 106 or step 104 is press-fit in a second assembly step with a plurality of punctiform segments 108 of the housing 18. In the exemplary embodiment, four segments 108 are provided which are arranged uniformly distributed on the mouth 66 of the housing opening 16, which mouth has a circular cross section (FIG. 6). For this purpose, a pressing force is exerted by a press-fitting tool 110 segmentally on the material of the housing 18 at the mouth 66, in such a way that the material is deformed on the individual segment 108 over the shoulder 106 (FIG. 7). The shoulder 106 is therefore segmentally overlapped by the deformed material of the housing 18. The guide element 70 is held on the housing 18 in the housing opening 16 by means of such segmental press-fitting.

During assembly, axial assembly forces 112, which are directed from the outside in the direction of the projection 72, occur while pressing-in and press-fitting (FIG. 7). These assembly forces 112 are absorbed by the projection 72 and transmitted to the housing 18. In addition, frictional forces occur during actuation of the brake pedal 30 and a forward movement of the piston rod 28 and the piston 26 caused thereby. Like the assembly forces 112, the frictional forces also act axially on the projection 72 from the outside and are transmitted from the projection 72 to the housing 18. Reduced forces therefore act from the outside to the inside on the guide element 70 and the sealing element 50.

Axial forces 114 which act from the inside to the outside or from the interior 20 in the direction of the projection 72 result from friction during a backward stroke of the piston 26 caused by releasing the brake pedal 30. In addition, these forces 114 also include functional forces generated by hydraulic pressure. The forces 114 act on the sealing element 50 placed on the projection 72, and are transmitted via the sealing element 50 to the projection 72 and from there to the housing 18. The outwardly acting forces 114 on the guide element 70 and on the segments 108 are therefore also reduced by means of the projection 72.

It has been shown that such a force transmission by the projection 72 on the entire housing 18 and the resulting reduced force in an axial direction is particularly easy on components and therefore also saves material. The sealing element 50 is therefore held by means of the projection 72 and is protected, and therefore reliably seals the passenger compartment as an additional seal. The sealing element 50 is therefore part of an expanded sealing concept for the IBP as a second insulation seal. In this case, the sealing element 50 offers a reliable additional safety seal which prevents the hydraulic fluid from contaminating an interior of a passenger compartment if it leaks through a first insulation seal that may be damaged.

In addition, the described segmental press-fitting and therefore only partial press-fitting of the housing 18 with the guide element 70 is sufficient to hold the guide element 70 in the housing opening 16 in a stable manner. Furthermore, it is sufficient for the guide element 70 to have a reduced press-in zone 116 and a reduced diameter 117 in comparison to the guide element 56. This creates a particularly space-saving and cost-effective brake actuating device 68 with reduced operating weight at the same time.

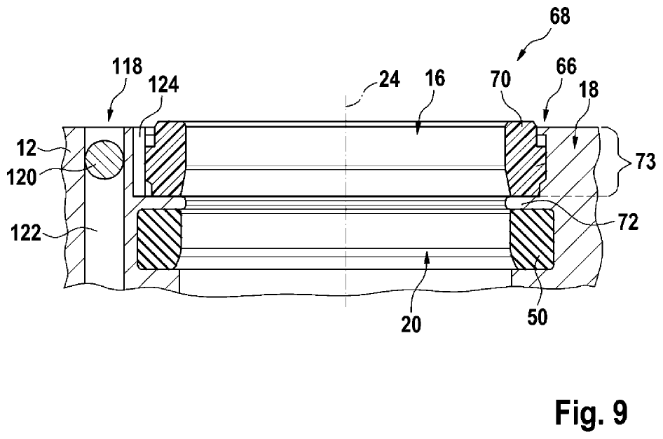

FIGS. 8 and 9 show the brake actuating device 68 in an exemplary embodiment in which three ball locks 118 arranged eccentrically to the housing axis 24 are provided peripherally to the housing opening 16 or interface. Each ball lock 118 includes a ball 120, which is in each case press-fit axially at the level of the guide region 73 and radially in the vicinity of the guide region 73 in a channel 122 arranged in the housing 18. Such ball press-fits or ball locks 118 lead to deformations in the guide region 73 of the housing opening 16.

For receiving each such deformation, an eccentrically arranged cavity 124 is provided radially outside the housing opening 16, axially at the level of the guide region 73 and in the region of the individual ball lock 118. The individual cavity 124 is therefore arranged radially adjacent to the guide region 73 peripheral to the associated channel 122 of the ball lock 118.

Each cavity 124 is therefore located in the pressing region of the guide element 70 and the associated ball lock 118. Due to the cavity 124, the deformation of the housing 18 by the associated ball lock 118 has no influence on a fit of the guide element 70 in the housing opening 16. Finally, the deformation accommodated by the cavity 124 does not overlap the centric diameter of the guide element 70. Defects in a guide between the piston 26 and the guide element 70 are therefore avoided.

In order to produce each cavity 124, a milling operation is carried out after interface machining a metal block used as a housing 18. The milling operation removes additional material axially at the level of the guide region 73 eccentric to the housing opening 16 and therefore forms the individual cavity 124. The cavity 124 is therefore designed as a recess.

What is claimed is:

1. A brake actuating device of a vehicle brake system, comprising:
a piston;
a pump housing having a wall that defines a housing opening, wherein the housing opening defines a housing axis along which the piston is configured to be accommodated in an axially displaceable manner, and wherein the housing opening further defines a guide region;
a guide element arranged in the guide region between the wall and the piston; and
a projection projecting from the wall into the housing opening,
wherein the projection is located axially next to the guide region in the housing opening, and
wherein the guide element is placed axially on the projection.

2. The brake actuating device according to claim 1, wherein the projection is formed integrally with the pump housing.

3. The brake actuating device according to claim 1, further comprising a sealing element, wherein:
the housing opening further defines a sealing region in which the sealing element is arranged,
the sealing region is arranged on a side of the projection opposite the guide region, and
the sealing element is located between the wall and the piston.

4. The brake actuating device according to claim 1, wherein the guide element possesses a radial outer surface which is designed with a transition fit so as to be positioned axially in the direction of the projection.

5. The brake actuating device according to claim 1, wherein the guide element possesses a radial inner surface which is designed with a bevel that is positioned axially in the direction of the projection.

6. The brake actuating device according to claim 1, wherein the guide element possesses a radial outer surface which is designed with a step that is directed radially inward and is positioned axially remote from the projection.

7. The brake actuating device according to claim 6, wherein at least one segment is provided, by way of which the step of the guide element and the pump housing are press-fit when the guide element is accommodated in the guide region.

8. The brake actuating device according to claim 7, wherein the at least one segment is punctiform.

9. The brake actuating device according to claim 1, wherein at least one cavity is provided radially next to the guide region outside the housing opening in the pump housing.

10. A use of a brake actuating device according to claim 1 in a master brake cylinder of the vehicle brake system.
